(19) United States
(12) Patent Application Publication
(10) Pub. No.: US 2026/0149174 A1
(43) Pub. Date: May 28, 2026

(54) SYSTEM AND METHOD FOR MEMS-TUNABLE MEMS STEERED ANTENNA ARRAY RADIATING ELEMENTS

(71) Applicant: Rockwell Collins, Inc., Cedar Rapids, IA (US)

(72) Inventors: Orion D. Davies, Cedar Rapids, IA (US); James B. West, Cedar Rapids, IA (US); Jonathan A. Lovseth, Marion, IA (US)

(21) Appl. No.: 19/397,070

(22) Filed: Nov. 21, 2025

Related U.S. Application Data
(60) Provisional application No. 63/723,967, filed on Nov. 22, 2024.

(51) Int. Cl. H01Q 3/26; H01Q 3/34

(52) U.S. Cl. CPC H01Q 3/2682; H01Q 3/34

(57) ABSTRACT

A micro-electromechanical systems (MEMS) steered antenna array may include micro-electromechanical systems which may mechanically steer the individual radiating antenna elements of the array independently from each other. The antenna elements may be mechanically steered to form subarrays which may be separately steered. The micro-electromechanical systems may mechanically adjust the orientation of the antenna elements for linear polarization control and to reduce shadowing from adjacent of the antenna elements. The micro-electromechanical systems may also adjust rotation independently to form sub-groups of elements to fine tune for a single polarization or a plurality of different polarizations. Individual control over physical positioning of directional radiating elements at the element level of an array system realizes the benefit of mechanically orienting the entire assembly, without the penalty of size, weight, power, and mechanical steering speed, while remaining a stationary platform and enabling an array to be adaptable in real time to various configurations.

### CROSS-REFERENCE

The present application claims the benefit under 35 U.S.C. § 119 of U.S. Provisional application 63/723,967, filed on Nov. 22, 2024, titled “SYSTEM AND METHOD FOR MEMS TUNABLE PHASED ARRAY RADIATING ELEMENTS”, which is incorporated herein by reference in the entirety.

### TECHNICAL FIELD

The present disclosure generally relates to arrangements for changing or varying the orientation or the shape of the directional pattern of the waves radiated from an antenna or antenna system, and more specifically to using mechanical relative movement between primary active elements and secondary devices of antennas or antenna systems.

### BACKGROUND

Electronic beam steering is physically limited by its optimized carrier frequency and by the magnitude of the steering angle of the main beam from boresight, which has a nominal maximum of 70 degrees. Electromechanical beam steering may be performed by controlling the amplitude and phase of signal at each radiating element and by controlling the physical orientation of the entire Electromechanical MEMS Steered array assembly through electromechanical steering.

Phased array antenna, also known as electronically scanned arrays, are optimized for half wavelength spacing at their highest frequency to eliminate grating lobes in visible space (horizon to horizon). Individual radiating elements typically take the form of conductor geometry defined by etch masking in a printed circuit board assembly process, or in the form of radiating structures (open ended waveguides, Vivaldi elements, etc.). The key challenge is to realize the required instantaneous bandwidth in a physical form factor compatible with 1/2 wavelength spacing at the higher operational frequency, the Nyquist sampling criteria for the highest operating frequencies wavelength (or less in some cases due to mutual coupling considerations) necessitate over-sampling at the lower

Mechanical steering of directional antennas can overcome the limitations of electronic steering although this requires bulky motors that suffer from reliability and excess weight/volume/power. More directional antennas generally require more mass, which drives the need for heavier motors and longer scan times (˜seconds). One example of mechanically steered directional arrays include state of the industry commercial avionics weather radar products. For example, large weather (WxR) flat plate slotted waveguide passive directional array mechanically scanned a rate of 45 deg/sec. These systems are stepper motor based and require significant DC power and sophisticated control systems for beam pointing accuracy.

Arrays are often constructed as fixed planar elements for easier manufacture as a printed circuit board. While this lowers construction cost. The element patterns of a planar phase array aperture is not omnidirectional due to the presence of a backing ground plane, but rather is generally approximated as cosⁿ(θ), where, n is greater of equal to 1.0, out to the desired beam scan angle, where θ is referenced of array normal when the array resides in the x/y plane and array normal is in the directions of the z axis.

Therefore, it would be advantageous to provide a device, system, and method that mitigates the shortcomings described above.

### SUMMARY

In some aspects, the techniques described herein relate to an array including all or some combination of: a plurality of mildly directional radiating antenna elements; a plurality of micro-electromechanical systems (MEMS) mechanically supporting the plurality of antenna elements and enabling precise position control; a substrate mechanically supporting the plurality of micro-electromechanical systems, wherein the plurality of micro-electromechanical systems are disposed between the plurality of antenna elements and the substrate; a beamformer, wherein the beamformer is configured to electrically steer the plurality of antenna elements at a plurality of beam steering angles and is configured to cause the plurality of micro-electromechanical systems to mechanically position the plurality of antenna elements at a plurality of mechanical steering angles with relatively fast speed; and a plurality of transmission lines, wherein the plurality of transmission lines connect the plurality of antenna elements and the beamformer.

In some aspects, the techniques described herein relate to a MEMS steered antenna array, wherein the plurality of antenna elements are directional antenna elements. In some aspects, the techniques described herein relate to a MEMS steered antenna array, wherein the plurality of antenna elements include at least one of rectangular, square, circular, single ridged (linear polarization), dual ridged (circular polarization) open-ended waveguides, patch-antenna elements, or Vivaldi-antenna elements, helical elements, dielectric resonator antenna (DRA) elements, and horn-elements. The horn element is a special case that will be described later herein.

In some aspects, the techniques described herein relate to an array, wherein the plurality of antenna elements are configured for at least one of W Band, (50-100) GHz, generally referred to as millimeter wave signals.

In some aspects, the techniques described herein relate to an array, wherein the beamformer is configured to control the plurality of micro-electromechanical systems by adjusting a voltage to the plurality of micro-electromechanical systems. Such a controller is described as the beam steering controller.

In some aspects, the techniques described herein relate to an array, wherein the plurality of mechanical steering angles are between surface normal and at least 30 degrees from array surface normal.

In some aspects, the techniques described herein relate to an array, wherein the plurality of transmission lines extend through a center of respective of the plurality of micro-electromechanical systems.

In some aspects, the techniques described herein relate to an array, wherein the plurality of transmission lines are flexible, such as flexible microstrip, stripline, shielded coplanar waveguide, coaxial or flexible dielectric waveguide connection.

In some aspects, the techniques described herein relate to an array, wherein the beamformer is configured to cause the plurality of micro-electromechanical systems to mechanically steer the plurality of antenna elements at the plurality of mechanical steering angles as the beamformer causes the plurality of antenna elements to steer at the plurality of electrical angles.

In some aspects, the techniques described herein relate to an array, wherein the beamformer is configured to electromechanically steer the plurality of antenna elements at the plurality of electrical steering angles and in increase the scan volume, electronic beam steering may be used to increase the array's Field of View (FoV).

In some aspects, the techniques described herein relate to a MEMS steered antenna array, wherein the beamformer is configured to perform polarization correction through a rotation of the plurality of antenna elements using the plurality of micro-electromechanical systems. This is advantageous for linearly polarized MEMS steered antenna array to obtain linear polarization match between the phase array and the propagating electromagnetic wave.

In some aspects, the techniques described herein relate to a MEMS steered antenna array, wherein the beamformer is configured to electromechanically tilt the plurality radiating elements to facilitate aperture beam steering.

In some aspects, the techniques described herein relate to a MEMS Steered Antenna array, generally operating at millimeter wave frequencies, wherein the beamformer is configured to cause the plurality of micro-electromechanical systems to compensate for shadowing between the plurality of antenna elements due to the plurality of mechanical steering angles by varying a piston of the plurality of antenna elements across the MEMS steered antenna array using the plurality of micro-electromechanical systems.

In some aspects, the techniques described herein relate to a MEMS steered antenna array, wherein the beamformer is configured to cause the plurality of micro-electromechanical systems to adjust the plurality of mechanical steering angles to random angles to reduce a radar cross section of the MEMS steered antenna array.

In some aspects, the techniques described herein relate to an array, wherein the plurality of antenna elements are grouped into a plurality of subarrays, wherein the beamformer is configured to mechanically steer the plurality of subarrays at different mechanical steering angles.

In some aspects, the techniques described herein relate to an array, wherein the MEMS steered antenna array is one of a planar array, a singly-curved conformal array, or a doubly-curved conformal array.

In some aspects, the techniques described herein relate to a MEMS steered antenna array, wherein the plurality of antenna elements are arranged in a rectangular, circular, spiral triangular, hexagonal, or random array lattice.

### BRIEF DESCRIPTION OF THE DRAWINGS

Implementations of the concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIGS. 1A-1B illustrates a simplified block diagram of a MEMS steered antenna array with antenna elements which are mechanically steered by micro-electromechanical systems, in accordance with one or more embodiments of the present disclosure.

FIG. 1C illustrates a simplified block diagram of the MEMS steered antenna array with antenna elements grouped into subarrays which are mechanically steered by micro-electromechanical systems, in accordance with one or more embodiments of the present disclosure.

FIGS. 2A-C illustrate a perspective view, a top view, and a side view respectively of the MEMS steered antenna array configured as a planar array with horn-antenna elements aligned at the normal axis, in accordance with one or more embodiments of the present disclosure.

FIGS. 2D-2F illustrate a partial perspective view, a partial top view, and a partial side view respectively of the array to more clearly illustrate one of the horn-antenna elements aligned at the normal axis, in accordance with one or more embodiments of the present disclosure.

FIGS. 2G-2I illustrate a perspective view, a top view, and a side view respectively of the MEMS steered antenna array with the horn-antenna elements aligned at a mechanical steering angle of 30° relative to the normal axis, in accordance with one or more embodiments of the present disclosure.

FIGS. 2J-2L illustrate a partial perspective view, a partial top view, and a partial side view respectively of the MEMS steered antenna array to more clearly illustrate one of the horn-antenna elements aligned at the mechanical steering angle of 30° relative to the normal axis, in accordance with one or more embodiments of the present disclosure.

FIG. 3A illustrates a perspective view of the MEMS steered antenna array with patch-antenna elements aligned at the normal axis, in accordance with one or more embodiments of the present disclosure.

FIG. 3B illustrates a perspective view of the MEMS steered antenna array with the patch-antenna elements aligned at a mechanical steering angle of 30° relative to the normal axis, in accordance with one or more embodiments of the present disclosure.

FIG. 4 illustrates a perspective view of the MEMS steered antenna array with subarrays of the antenna elements, in accordance with one or more embodiments of the present disclosure.

FIGS. 5A-5B illustrate side views of the MEMS steered antenna array with the antenna elements before and after a piston to compensate for shadowing due to the mechanical steering angle, in accordance with one or more embodiments of the present disclosure.

FIGS. 6A and 6B illustrate a perspective view of the MEMS steered antenna array configured as a singly-conformal (cylindrical) array with the horn-antenna elements which are respectively aligned at the normal axis and electromechanically elevation scanned, in accordance with one or more embodiments of the present disclosure.

FIG. 7 illustrates the MEMS steered antenna array configured as a doubly-curved conformal array with the horn-antenna elements aligned at the normal axis, in accordance with one or more embodiments of the present disclosure.

FIG. 8 illustrates the MEMS steered antenna array with a ball-and-socket joint, in accordance with one or more embodiments of the present disclosure.

FIG. 9A illustrates a simplified block diagram of the MEMS steered antenna array with variable attenuators, in accordance with one or more embodiments of the present disclosure.

FIG. 9B illustrates examples of the variable attenuators, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details are set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1,1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Micro Electrical Mechanical Systems (MEMS) micro-mirror components are used to control light reflections. Such components are manufacturable, small, reliable, and offer controlled tilt. Texas Instruments Digital Light Projection (DLP) and Bright Silicon Technologies Lightfield Directing Array (LDA) are two examples. These devices physically move state in 45μsec. This movement speed is quoted for a very low mass and Center of Gravity (Cg) mechanical payload. These scan rates are applicable to millimeter wave MEMS Steered Antenna arrays, but will be slower for MEMS steered antenna array applications <50 GHz since such arrays will have more challenging mass and center of gravity (Cg) requirements due to the physical size of the radiating elements in terms of wavelength.

U.S. Pat. No. 10,444,492, titled “Flexure-based, tip-tilt-piston actuation micro-array”; is incorporated herein by reference in the entirety.

Reference will now be made in detail to the subject matter disclosed, which is illustrated in the accompanying drawings. Embodiments of the present disclosure are directed to a system and method for MEMS tunable MEMS Steered Antenna array radiating elements. An array may include micro-electromechanical systems which may mechanically steer the antenna elements of the array. The antenna elements may be mechanically MEMS Steered to form subarrays which may be separately MEMS Steered. The micro-electromechanical systems may also mechanically adjust the orientation of the antenna elements for linear polarization control and to reduce shadowing from adjacent of the antenna elements. The electronically MEMS Steered array technology is extremely low-cost while also realizing as minimal average DC power consumption as possible.

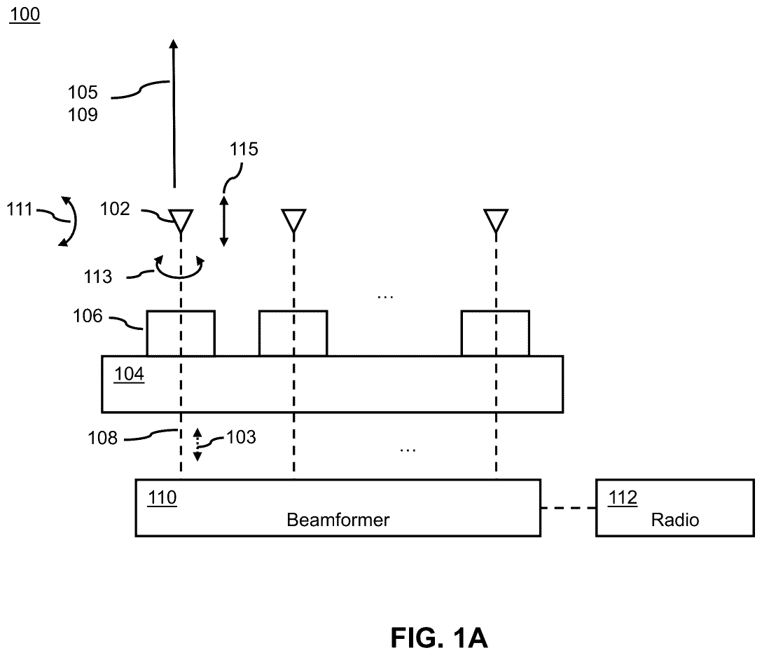

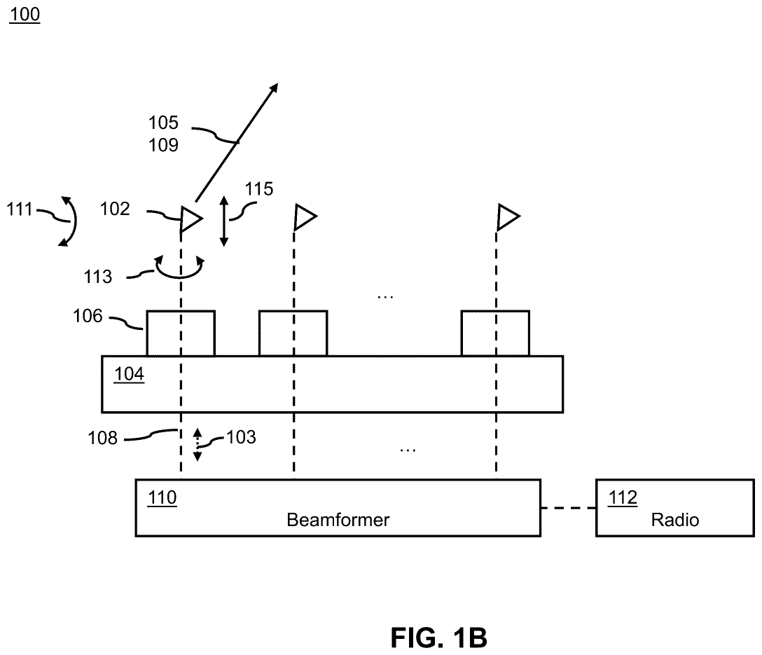

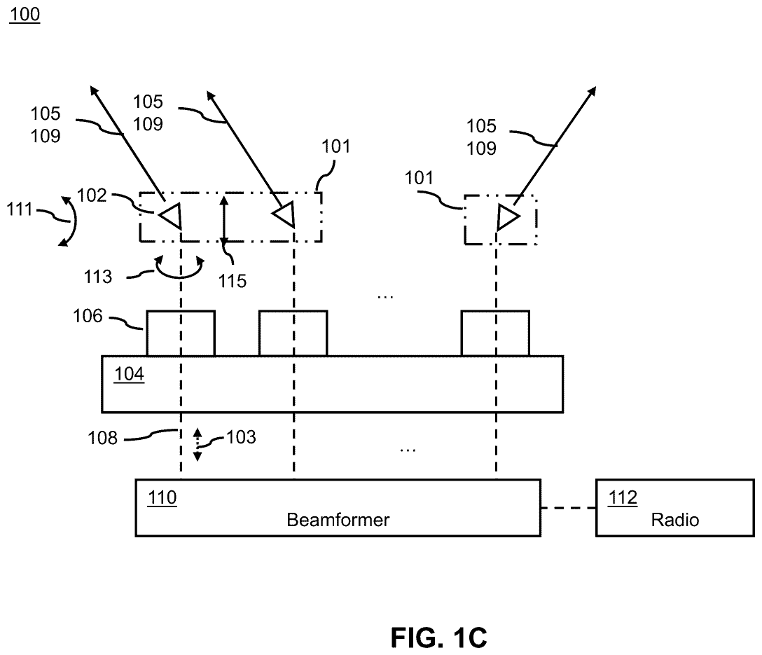

FIG. 1A-1C illustrates a MEMS steered antenna array 100, in accordance with one or more embodiments of the present disclosure. The MEMS steered antenna array 100 may include one or more components. For example, the MEMS steered antenna array 100 may include the antenna elements 102, the substrate 104, the micro-electromechanical systems 106 (MEMS), the transmission lines 108, a beamformer 110, a radio 112, and the like.

The substrate 104 may mechanically support one or more components of the MEMS steered antenna array 100. For example, the substrate 104 may mechanically support the antenna elements 102, the micro-electromechanical systems 106, the transmission lines 108, the beamformer 110, the radio 112 or the like. The substrate 104 may be any suitable substrate material. For example, the substrate 104 may be an organic printed wiring board, a ceramic printed wiring board, a glass interposer, a silicon wafer, or the like.

The antenna elements 102 may include any suitable type of antenna elements for the MEMS steered antenna array 100. For example, the antenna elements 102 may include, but are not restricted to, horn-antenna elements 102a, patch-antenna elements 102b, open-ended waveguide elements, transverse electromagnetic (TEM) notch elements, Vivaldi-antenna elements, Balanced Antipodal Vivaldi-antenna (BAVA) elements, dipole elements, printed antenna elements, spiral elements, helical elements, dielectric resonator elements, slot elements, dielectric resonator antenna (DRA) elements, and the like. Only the horn-antenna elements 102a and the patch-antenna elements 102b are depicted in the drawing for conceptual clarity and brevity. Numerous other antenna elements commonly known in literature are applicable. The open-ended waveguide elements may be rectangular, square, circular, single ridged (linear polarization), and/or dual ridged (circular polarization) open-ended waveguides. Horn antennas are a special case that is advantageous for electromechanical only beam scanned systems without electronic beam scanning.

The antenna elements 102 may include the antenna pattern. The antenna pattern may include any suitable pattern in azimuth and/or elevation. The antenna pattern of the antenna elements 102 may be based on the type of the antenna elements 102. For example, the antenna elements 102 may include cardioid/cosⁿ(θ) or more directional antenna patterns in azimuth and/or elevation for the case where the array lattice space is in between ½-1 wavelength. For example, the higher gain directional antenna patterns in azimuth and/or elevation may be beneficial to increase the gain of the main lobes of the directional antenna patterns for the electromechanical-only MEMS Steered Antenna Array embodiment. Mechanical steering using the micro-electromechanical systems 106 may allow the directional antenna patterns to achieve higher gains than the cardioid/cosⁿ(θ) antenna pattern. The higher gains is true primarily for planar apertures since the scan projection loss is eliminated. Conformal arrays generally do not suffer scan loss in the plane of curvature. One significant advantage of the electrometrically scanned phase array is that the concepts or aperture projection loss, and the like, as commonly known for an electronically scanned array do not apply since beam steering is enabled by literally tipping of the array aperture. The tipping of the array aperture allows the element-to-element space to be larger, theoretically up to one wavelength for grating lobe-free operation, rather than the 1/2 wavelength required for traditional planar phase array grating lobe free operation. The relaxed array lattice spacing allows for physically larger/higher radiating elements, such as horns for higher overall aperture gain without element-to-element mechanical collisions. The antenna elements 102 may be used on receive and/or transmit. The antenna elements 102 may receive and/or transmit the radio signals 103 with the antenna pattern. The directional antenna elements for the electromechanical-only array architecture may have may have a maximum gain as allowed by the maximum collision-free displacements under tilt, tip, and piston displacements within the aperture size.

The antenna elements 102 may be configured for any suitable wavelength that meets the restrictions surrounding the mechanical payload requirements of the MEMs actuator-based system in terms of mass, center of gravity, bending moment, torque, and the like. The concepts of the MEMS steered antenna array 100 may scale to any wavelength that is compatible with the mass and center of gravity (Cg) of a maximum mechanical payload for the electromechanical motion system. The radio signals 103 may be a high-frequency signal. The antenna elements 102 may be electrically long/narrow antennas. For example, the antenna elements 102 may be typically 1/2 wavelength or larger, if the antenna elements 102 are collision-free and do not create excessive inter-element shadowing. The antenna elements 102 may be configured for a W Band (e.g., 50-100 GHz), generally referred to as millimeter wave signals, although this is not intended to be limiting.

The antenna elements 102 may be arranged with a select spacing between adjacent of the antenna elements 102. For example, the antenna elements 102 may be arranged with a half-wavelength spacing for a hybrid electromechanical/electronic system, and less than or equal to one-wavelength for a pure electromechanical system between the antenna elements 102.

The transmission lines 108 may be configured to carry the radio signals 103. The transmission lines 108 may connect the antenna elements 102 through a feed distribution manifold and the beamformer 110. Each of the antenna elements 102 may be separately connected to feed manifold and/or the beamformer 110 by respective of the transmission lines 108. The transmission lines 108 may feed any suitable portion of the antenna elements 102, the specifics of which may be based on the type of antenna elements 102. The transmission lines 108 may connect with the antenna elements 102 using any suitable type of coupling, such as, but not limited to, direct metallic connection or capacitive coupling.

The antenna elements 102 may include a plurality of different polarization types such as linear vertical, horizon or slant 45° linear, right hand circular, left hand circular or arbitrary elliptical polarization states. For example, linear polarization adjustment can be electrometrically controlled through element rotation.

The micro-electromechanical systems 106 may mechanically support the antenna elements 102. Each of the antenna elements 102 may be mechanically supported by respective of the micro-electromechanical systems 106. The micro-electromechanical systems 106 may mechanically couple between the antenna elements 102 and the substrate 104. The micro-electromechanical systems 106 may be centered on the antenna elements 102. The antenna elements 102 may be disposed on the micro-electromechanical systems 106. The antenna elements 102 being disposed on the micro-electromechanical systems 106 may be advantageous such that the micro-electromechanical systems 106 are spaced away from the radiation layer of the antenna elements. The micro-electromechanical systems 106 and beamformer 110 may be behind the antenna elements 102. The antenna elements 102 may be spaced off the substrate 104 with the micro-electromechanical systems 106 between the substrate 104 and the antenna elements 102. The micro-electromechanical systems 106 may be underneath the antenna elements 102. The micro-electromechanical systems 106 may be manufactured on the substrate 104.

The micro-electromechanical systems 106 may change the orientation of the antenna pattern radiated from the MEMS steered antenna array 100 using mechanical movement of individual of the antenna elements 102. The micro-electromechanical systems 106 may add one or more degrees-of-freedom to radio frequency beam steering through mechanical steering of the antenna elements. The micro-electromechanical systems 106 may mechanically steer the position and/or orientation of the antenna elements 102 relative to the substrate 104. The antenna elements 102 may mechanically steer the radiating elements such that the boresight is angled away from the surface normal. The micro-electromechanical systems 106 may mechanically steer at least one of the position or the orientation of the antenna elements 102. For example, the micro-electromechanical systems 106 may steer the tip 111, the tilt 113, and/or the piston 115 of the antenna elements 102. The tip 111 and/or the tilt 113 may be a rotation of the antenna elements 102. The tip 111 may be rotation of the antenna elements 102 with vector components about orthogonal planes of the antenna elements 102 (e.g., orthogonal to the normal axis). The tip 111 may be about either of the orthogonal planes. The tilt 113 may be rotation of the antenna elements 102 with vector components to the normal axis. The normal axis may also be referred to as a vertical axis. The piston 115 may be translation of the antenna elements 102 along the normal axis (e.g., up & down). The tip 111, the tilt 113, and/or the piston 115 of the antenna elements 102 may be mechanically steer the antenna elements 102 relative to the substrate 104. The micro-electromechanical systems 106 may perform the tip 111, the tilt 113, and/or the piston 115 at the phase center of the antenna elements 102. Each of the antenna elements 102 in the MEMS steered antenna array 100 may be mechanically steered individually by respective of the micro-electromechanical systems 106.

The micro-electromechanical systems 106 may be any suitable micro-electromechanical systems for steering the position and/or orientation of the antenna elements 102. The micro-electromechanical systems 106 may be MEMS actuators.

The beamformer 110 may also be referred to as an electromechanical controller. The beamformer 110 may control the micro-electromechanical systems 106. For example, the beamformer 110 may be connected to the micro-electromechanical systems 106. The micro-electromechanical systems 106 may be voltage-controlled. The beamformer 110 may control the micro-electromechanical systems 106 by adjusting a voltage to the micro-electromechanical systems 106. The beamformer 110 may cause the micro-electromechanical systems 106 to mechanically steer the antenna elements 102 at the mechanical steering angles 109.

The micro-electromechanical systems 106 may mechanically steer the antenna elements 102 at the mechanical steering angles 109. The antenna elements 102 may be mechanically steered at the mechanical steering angles 109 by the tilt 113. The mechanical steering angles 109 may be mechanically steered between 0° from surface normal up to an upper limit. The upper limit of the mechanical steering angles 109 may be based on shadowing of the antenna elements 102 by adjacent of the antenna elements 102 and/or the micro-electromechanical systems 106, abutment (e.g., mechanical collision) between adjacent of the antenna elements 102 and/or the micro-electromechanical systems 106, limitations in flexibility of the transmission lines 108, and the like. The mechanical steering angles 109 may be up to any suitable angle. For example, the mechanical steering angles 109 may be between surface normal and at least 30 degrees to 60 degrees from surface normal, depending on the radiating element utilized. The beamformer 110 may cause the micro-electromechanical systems 106 to mechanically steer the antenna elements 102 at the mechanical steering angles 109.

The transmission lines 108 may be flexible. The transmission lines 108 may be any suitable flexible transmission line, such as, but not limited to, a flexible-printed circuit, a coaxial cable, a flexible microstrip, a stripline, a shielded coplanar waveguide, a flexible dielectric waveguide connection, or the like. For example, the transmission lines 108 may be the flexible-printed circuit. The flexible-printed circuit may be a plastic holding copper traces.

The flexibility of the transmission lines 108 may allow the transmission lines 108 to maintain the connection between the antenna elements 102 and the beamformer 110 with the mechanically steering of the antenna elements 102. The transmission lines 108 may maintain the connection between the antenna elements 102 and the beamformer 110 as the micro-electromechanical systems 106 mechanically steer the antenna elements 102 at the mechanical steering angles 109. The transmission lines 108 may have sufficient slack to maintain the connection even as the micro-electromechanical systems 106 cause the antenna elements 102 to the tip 111, the tilt 113, and/or the piston 115.

The transmission lines 108 may be arranged at any suitable position relative to the substrate 104 and/or the micro-electromechanical systems 106. For example, the transmission lines 108 may extend through the center of respective of the micro-electromechanical systems 106. The transmission lines 108 may couple to and/or through the substrate 104 by which the transmission lines 108 connect with the beamformer 110.

The electromechanical tilting of the antenna elements 102 may mitigate the scan projection loss of a linear or planar MEMS Steered Antenna Array, under the assumption of minimal inter-element shadowing of adjacent radiating elements. The new “boresight normal” of the aperture is now at the tilted radiating element normal due to the electromechanical mechanical pointing position of the radiating elements in concert. This is physically akin to a physically tipped the planar aperture now with a new array normal.

The micro-electromechanical systems 106 may scan the antenna elements 102 by the electromechanical beam steering. Scanning may refer to steering the antenna elements 102 in a scanning pattern (e.g., a conical scan pattern, a raster scan pattern, or the like). The scanning may be repetitive motion of the major lobe. The antenna elements 102 may be electromechanically scanned at a scan rate. The scan rate of the micro-electromechanical systems 106 may be any suitable time. The scan rate may be on the order of tens of microseconds or hundreds of microseconds. For example, the scan rate may be between about 45 microseconds and 450 microseconds. For instance, the scan rate of the electromechanical beam steering may be 45 microseconds plus the delays imposed by the inertial mass of the supported radiating element. Various factors may impact the scan rate, such as, but not limited to, the mass, center of gravity (Cg), bending moment, and the like of the antenna elements 102, such that the example times provided above are not intended to be limiting.

The MEMS steered antenna array 100 may be a hybrid antenna array. The antenna elements 102 may be electrically steered by the beamformer 110 shifting the phase and/or time delay of the antenna elements 102. In addition to electromechanical beam steering as previously described, the beamformer 110 may control the phase and/or time delay of the antenna elements 102. The beamformer 110 may separately adjust the phase and/or time delay to each of the antenna elements 102 to scan the radio signals 103 at the electrical steering angles 105. Changing the phase and/or time delay of the antenna elements 102 may change distribution of energy across the MEMS steered antenna array 100. The electrical steering angles 105 may be any suitable angle in elevation and azimuth. The antenna elements 102 may be controlled to electrically steer the antenna elements 102 at the electrical steering angles 105. In the hybrid antenna array architecture, digital and/or analog inter-element phase shift and/or time delay scanning techniques may enhance the scan volume and/or field-of-view (FoV) of the mechanical steered system to offset the limitations/bottlenecking of the electromechanical element tipping and tilting.

The beamformer 110 may perform linear polarization correction through the tilt 113 of the antenna elements 102. The antenna elements 102 may be rotated about the center axis for the linear polarization mismatch correction. The polarization correction may reduce a polarization loss factor (PLF) of the MEMS steered antenna array 100. The polarization of the antenna elements 102 may be misaligned. For example, the polarization of the antenna elements 102 may be polarization misaligned due to mechanical misalignment, or the like. If the polarization of the antenna elements 102 are misaligned, the polarization loss factor may reduce the gain of the antenna elements 102. The beamformer 110 may cause the micro-electromechanical systems 106 to perform the tilt 113 of individual of the antenna elements 102 to correct for the polarization misalignment. The micro-electromechanical systems 106 may perform the tilt 113 of individual of the antenna elements 102 relative to the normal axis of the antenna elements 102 to correct for the misalignment. The beamformer 110 may make a fine adjustment by the tilt 113 of the antenna elements 102 into alignment. The benefit of aligning the polarization may be to increase the gain and increase the range that MEMS steered antenna array 100 is able to transmit and receive. Controlling the tilt 113 may enable the MEMS steered antenna array 100 to achieve greater control over polarization when transmitting the radio signals 103 by establishing a precise orientation for each of the antenna elements 102.

One challenge with the mechanical steering of the antenna elements 102 may be shadowing between adjacent of the antenna elements 102. The shadowing may refer to a situation where the line-of-sight of the antenna elements 102 are partially or fully blocked by the adjacent of the antenna elements 102. The shadowing may increase as the antenna elements are mechanically MEMS Steered to higher of the mechanical steering angles 109. The proposed electromechanical element as previously described herein may be able to compensate element shadowing for millimeter wave systems by vertical displacement of the radiating element to establish a “new local aperture plane.” The amount of vertical displacement required to prevent element showing is a direct function of the MEMS Steered Antenna Array's operational frequency (wavelength) of the radiating elements in addition of the previously described element tipping. The beamformer 110 may cause the micro-electromechanical systems 106 to compensate for the shadowing between the antenna elements 102 by varying the piston 115 of the antenna elements 102 across the MEMS steered antenna array 100. For example, the micro-electromechanical systems 106 may perform the piston 115 downwards of the antenna elements 102 which are arranged at the closest end of the MEMS steered antenna array 100 in which the antenna elements 102, with the piston 115 increasing the space between the antenna elements 102 and the substrate 104 from the closest end to the furthest end. The beamformer 110 may cause the micro-electromechanical systems 106 to vary the piston 115 by a linear amount across the MEMS steered antenna array 100. Thus, the piston 115 may be beneficial at higher of the mechanical steering angles 109 to overcome the shadowing from the adjacent of the antenna elements 102.

Performing the tip 111, the tilt 113, and/or the piston 115 of the antenna elements 102 may or may not change the phase center locations of each of the antenna elements 102 with respect to the element phase center. The tip 111, the tilt 113, and the piston 115 of the antenna elements 102 may assist in properly aligning the phase center of the antenna elements 102 relative to one another.

The beamformer 110 may cause the micro-electromechanical systems 106 to mechanically steer the antenna elements 102 and misalign the antenna elements 102. For example, the beamformer 110 may cause the micro-electromechanical systems 106 to adjust the mechanical steering angles 109 to random angles. The mechanical steering of the antenna elements 102 may be deliberately misaligned when the MEMS steered antenna array 100 is not transmitting and receiving. Misaligning the mechanical steering of the antenna elements 102 may reduce a radar cross section (RCS) of the MEMS steered antenna array 100 when it is in an un-energized state by reducing Bragg scattering. Reducing the radar cross section (RCS) of the MEMS steered antenna's aperture may be at the penalty of reducing the performance of the array since it would create a random array in terms of inter-radiating element phase center migration, but nevertheless it is a strong technique for lower RCS for the aperture when it is not operational and in the “off” state. By pointing the aperture of each element in the off in random directions, there is no longer a coherent summation of the return, but rather are each scattered across a wide field-of-view (FoV) for an aggregate omnidirectional specular reflection as opposed to focus coherent reflection in accordance geometric optic theory. Alternatively, in some operational concept scenarios, the aperture can be mechanically misaligned such that it is reconfigured to operate akin to a digital radio frequency memory (DFRM) to spoof an adversarial radar.

The radio 112 may be connected to the beamformer 110. The radio 112 may control the beamformer 110. The radio 112 may be a digital back-end of the MEMS steered antenna array 100. The radio 112 may provide one or more functions. For example, the radio 112 may include waveform processing including subarray-level digital bam forming, modulation and demodulation, etc. Further, electromechanically actuated aperture as described herein can be embodied as a pure element-level digital beamformed (DBF) beaming hybrid system to realize the advantages of no aperture projection losses, and the like. By way of another example, the radio 112 may perform frequency (up/down) conversion, amplification, signal mixing, and the like. The radio 112 may include one or more components for performing said functions. For example, the radio 112 may include a transmitter, a receiver, and the like.

The antenna elements 102 may be mechanically steered as an antenna array and/or as subarrays 101. The antenna elements 102 may be grouped into an antenna array. Each of the antenna elements 102 in the antenna array may be mechanically MEMS Steered at the same of the mechanical steering angles 109. The antenna array may be used to communicate with one location.

The MEMS steered antenna array 100 may include the subarrays 101. The antenna elements 102 may be grouped into subarrays 101. The subarrays 101 may each include any number of the antenna elements 102. The beamformer 110 may be configured to mechanically steer the subarrays 101 at different of the mechanical steering angles 109 and the electrical steering angles 105. Each of antenna elements 102 within the subarrays 101 may be steered at the same of the mechanical steering angles 109 The antenna elements 102 between the subarrays 101 may be MEMS Steered at the different of the mechanical steering angles 109 For example, each of the antenna elements 102 in respective of the subarrays 101 may be mechanically MEMS steered at the same of the mechanical steering angles 109 and/or electrically MEMS Steered at the same of the electrical steering angles 105. The micro-electromechanical systems 106 may perform the tip 111, the tilt 113, and/or the piston 115 for each of the antenna elements 102 within the subarrays 101.

The MEMS steered antenna array 100 may support multiple waveforms steering in different directions from the subarrays 101. The subarrays 101 may configure the MEMS steered antenna array 100 to source and/or receive different waveforms at different frequencies and/or different polarizations at the electrical steering angles 105. The MEMS steered antenna array 100 may be a multi-function aperture (MFA). For example, the MEMS steered antenna array 100 may be configured to perform radar sensing, communications, and/or electronic warfare simultaneously using the subarrays 101. 109. The subarrays 101 may transmit and/or receive at the electrical steering angles 105 to avoid jamming and/or being jammed by a third party between the electrical steering angles 105. The beamformer 110 may perform multi-beam, dynamic nulling using the subarrays 101.

The size of the subarrays 101, including the number of the antenna elements 102 in each of the subarrays 101, may be selected to reject interference and balance the signal-to-noise ratio (SNR) from sources in multiple directions. Each of the groupings of the antenna elements 102 in respective of the subarrays 101 may also be optimized for different carrier frequencies (e.g., based on the electrical size of the antenna elements 102). The beamformer 110 may independently tune the subarrays 101.

The MEMS steered antenna array 100 may be arranged in any suitable array, such as, but not limited to, a planar array 100a, a singly-curved conformal array 100b, a doubly-curved conformal array 100c, or the like. The planar array 100a, the singly-curved conformal array 100b, and/or the doubly-curved conformal array 100c may include the antenna elements 102. Suitable additional array lattice configurations include linear, rectangular, circular, triangular, hexagonal, spiral, wavelength scaled, log-periodic, thinned, and random arrays. The array lattice configuration selected is based on system dependent advantages and disadvantages, and is not intended to be limited to any single aperture lattice configurations for all for communicators, direction finding, radar, electronic warfare (EW, e.g. SIGINT, ELINT, ESM, etc.) RF sensor system applications.

The substrate 104 may be any suitable shape. For example, the substrate 104 may be a planar substrate 104a, a singly-curved substrate 104b, or a doubly-curved substrate 104c. The singly-curved substrate 104b may support the singly-curved conformal array 100b. The doubly-curved substrate 104c may support the doubly-curved conformal array 100c. The planar substrate 104a may be any planar shape, such as, but not limited to, a rectangle, a square, a hexagon, or the like. The singly-curved substrate 104b may be any suitable shape which is one-dimensional curved, such as, but not limited to, a piecewise plant faceted hexagonal prism, a cylinder, or the like. The doubly-curved substrate 104c may be any shape which is three-dimensional structures, such as, but not limited to, a piecewise planar faced 3D doubly structure, a cone, a spherical segment, a spherical cap, a hemisphere, or the like.

In embodiments, the MEMS steered antenna array 100 may be the planar array 100a. The MEMS steered antenna array 100 may include any suitable M-by-N planar array, where M and N are integers. The M number and the N number of the antenna elements 102 may be the same or different.

The antenna elements 102 may be arranged in rows and columns. The rows and columns of the antenna elements 102 may or may not be aligned across the MEMS steered antenna array 100. For example, the antenna elements 102 may be arranged in a linear, rectangular, triangular, hexagonal, or wavelength scaled, or pseudo-random, sparse element lattice arrangement. Although the antenna elements 102 are described as being arranged in the triangular lattice, this is not intended to be limiting. For the rectangular and rotationally symmetric circular array lattice, the lattice structure may be beneficial to maintain the half-wavelength spacing or slightly less between each of the antenna elements 102 across the MEMS steered antenna array 100. It is contemplated that the triangular, hexagonal, and sparse variant lattices may be particularly beneficial due to the shape of the micro-electromechanical systems 106. For example, the triangular lattice may maximize a spacing of the antenna elements 102 in a single dimension while keeping the antenna elements 102 and the micro-electromechanical systems 106 as close as possible to adjacent of respective of the antenna elements 102 and the micro-electromechanical systems 106 in the MEMS steered antenna array 100. By way of another example, the non-uniform x/y dimensional array lattices may enable mechanically steering the position of the antenna elements 102 using the without collisions between the antenna elements 102 and/or the micro-electromechanical systems 106.

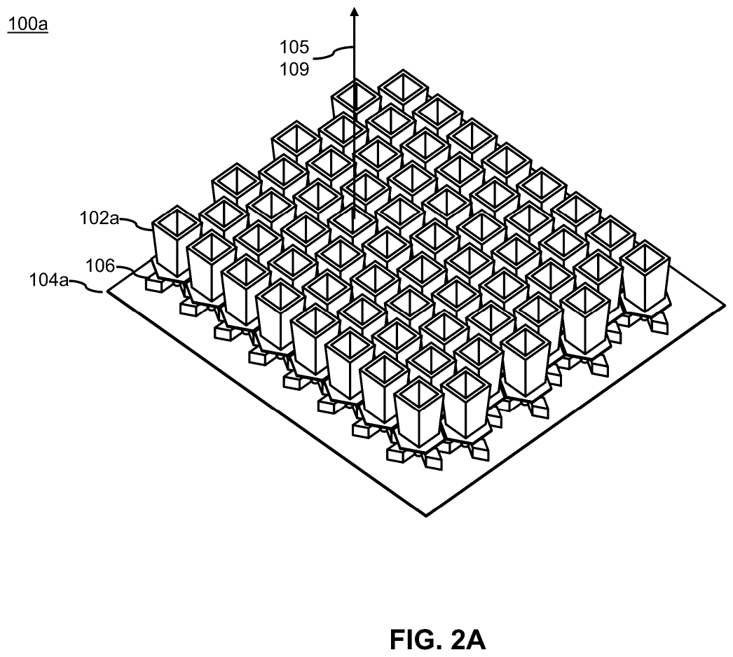

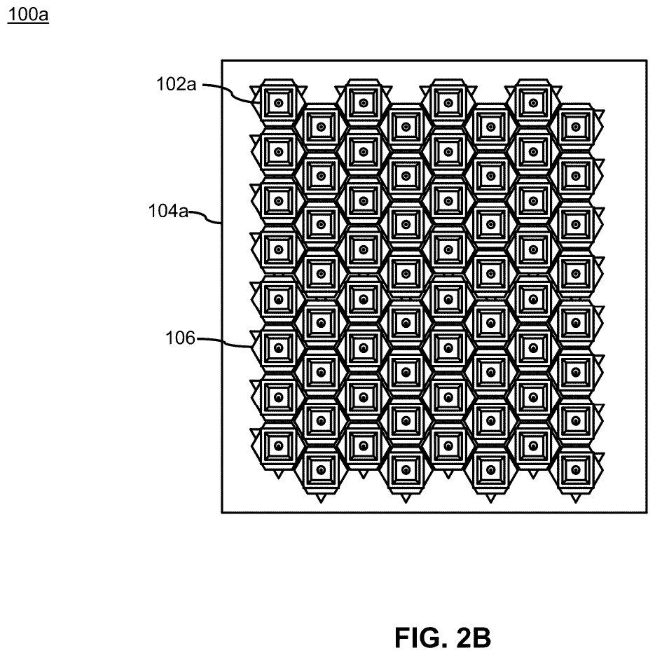

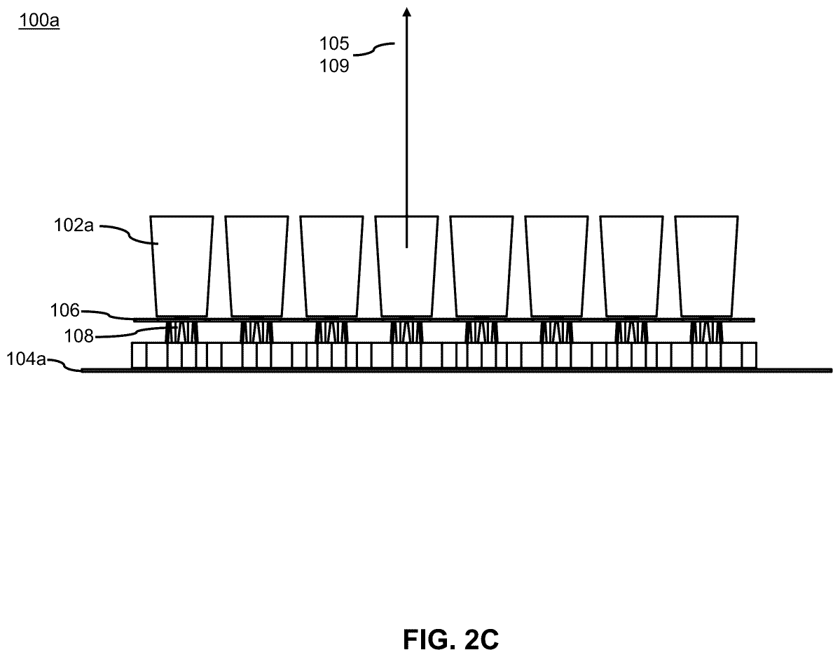

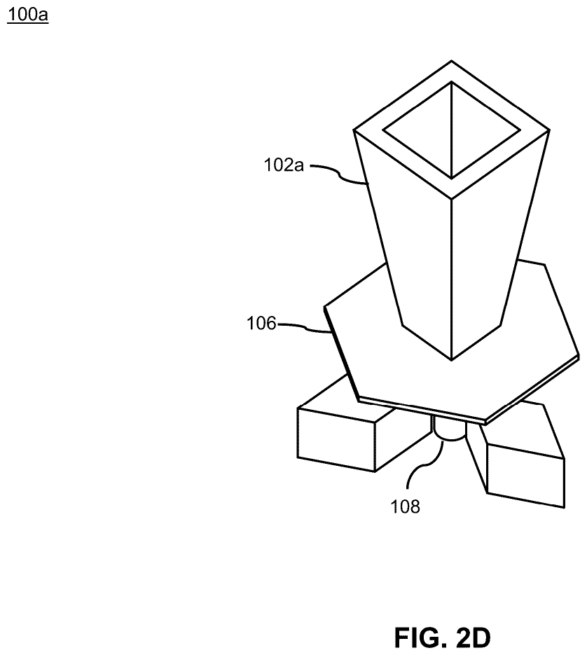

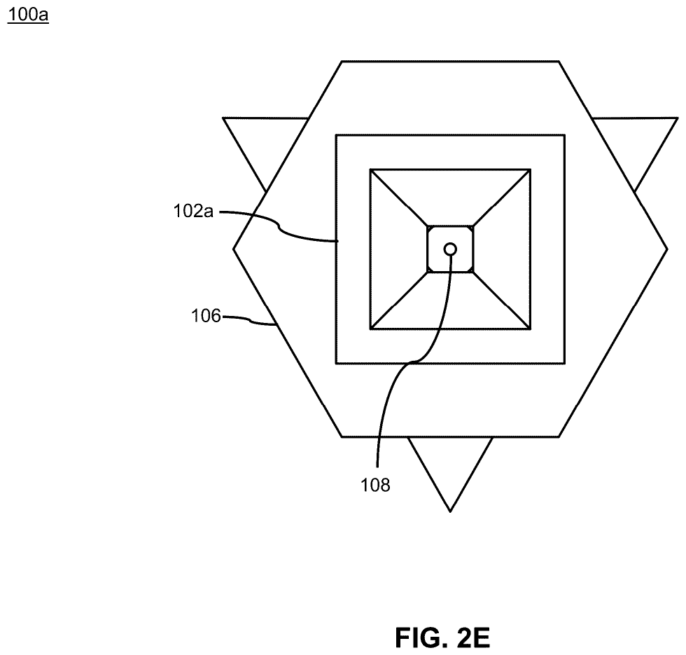

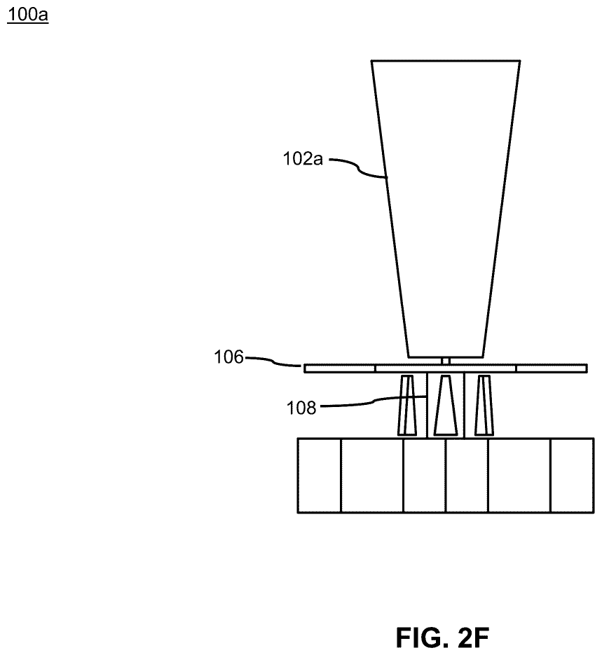

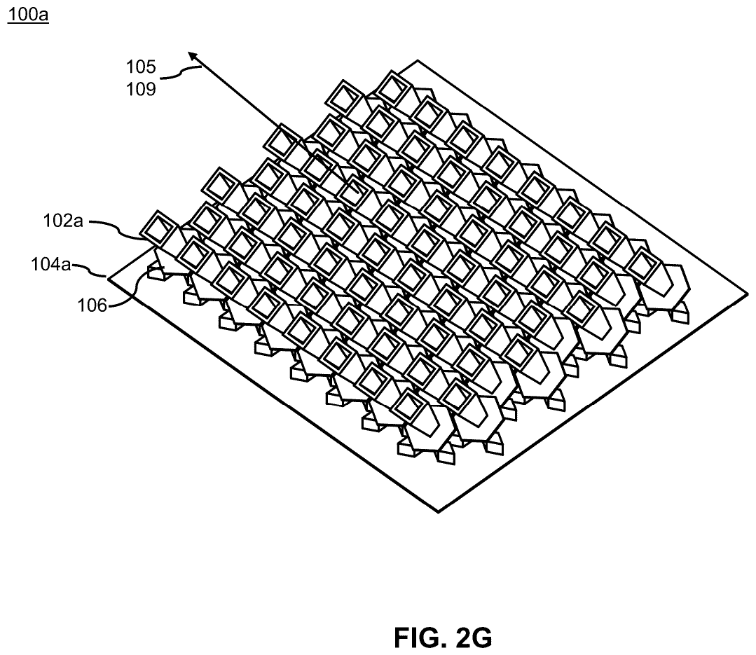

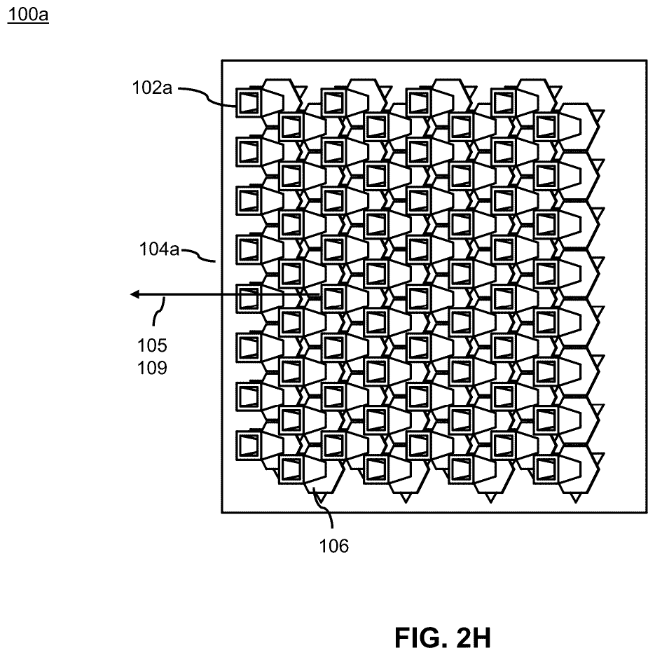

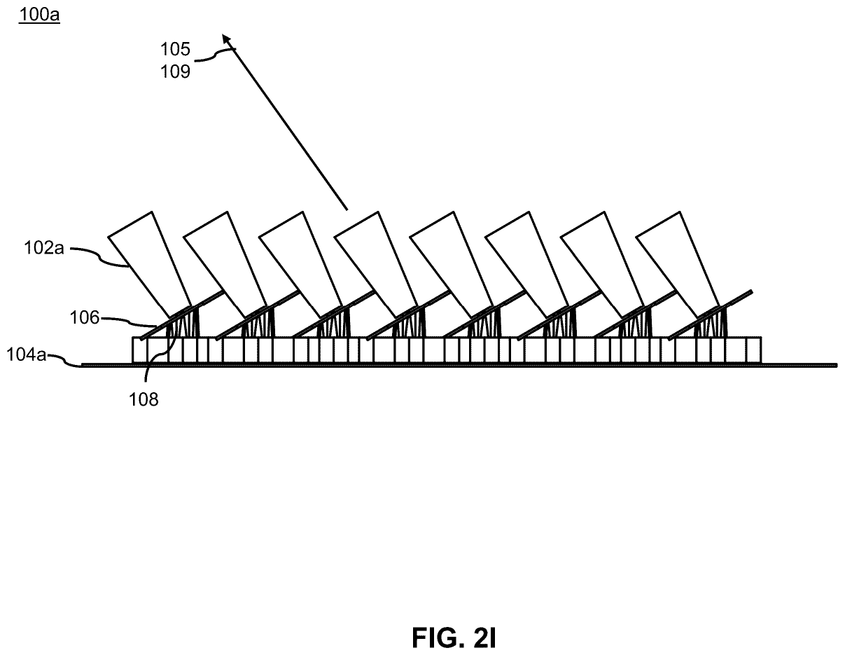

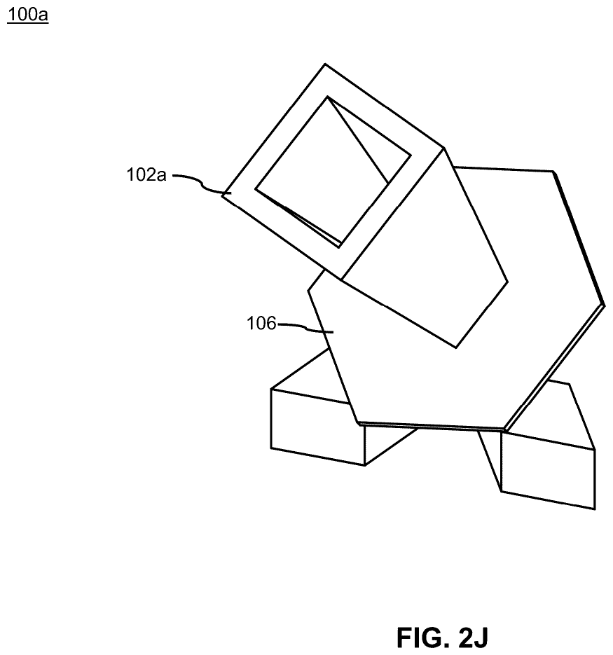

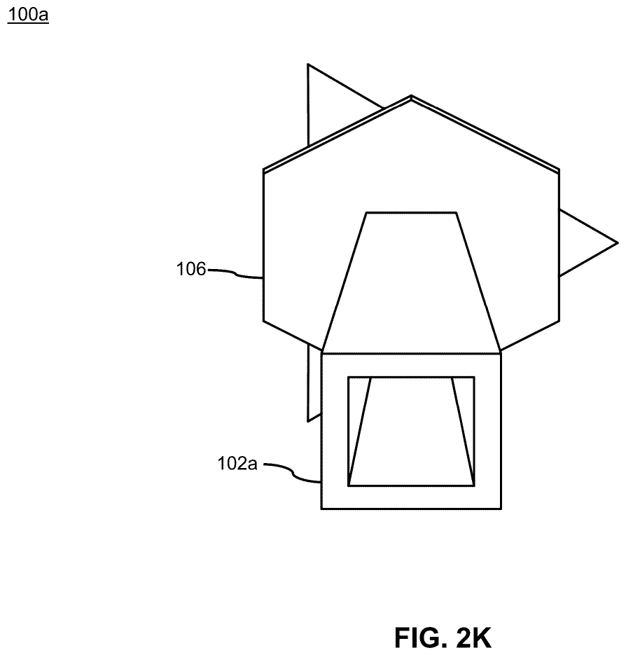

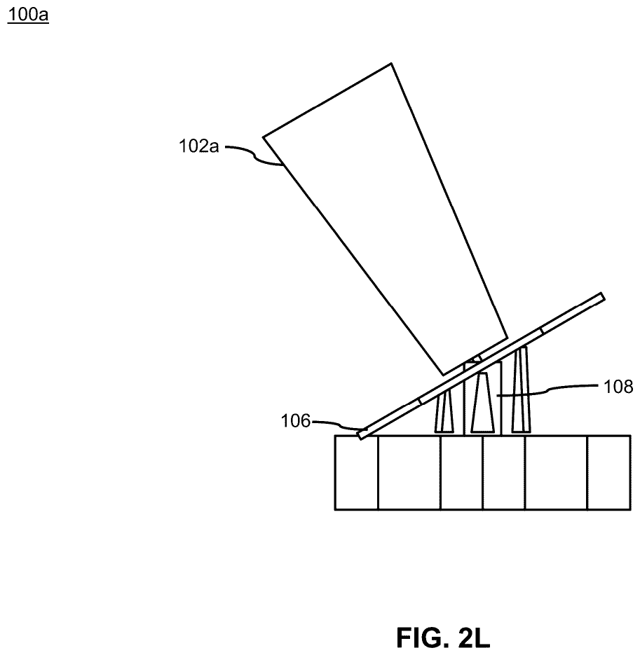

FIGS. 2A-2L illustrate an example of the MEMS steered antenna array 100, in accordance with one or more embodiments of the present disclosure. In this example, the MEMS steered antenna array 100 is the planar array 100a. The substrate 104 is the planar substrate 104a. In this example, the MEMS steered antenna array 100 includes the antenna elements 102 which are the open-ended waveguide or horn-antenna elements 102a. The antenna elements 102 are arranged in the triangular lattice in an 8 -by-8 configuration. The micro-electromechanical systems 106 are illustrated as changing the mechanical steering angles 109 of the antenna elements 102 from being at the normal axis (e.g., 0°) to being 30° relative to the normal axis.

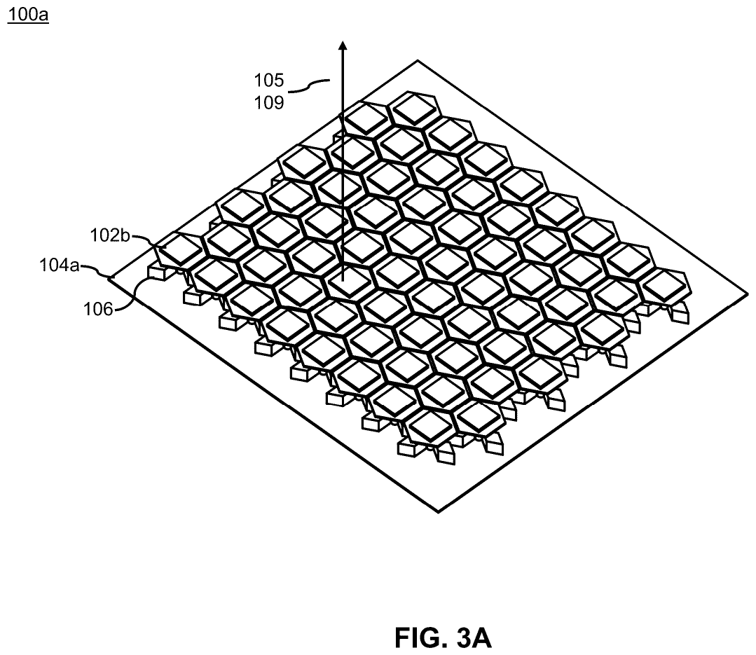

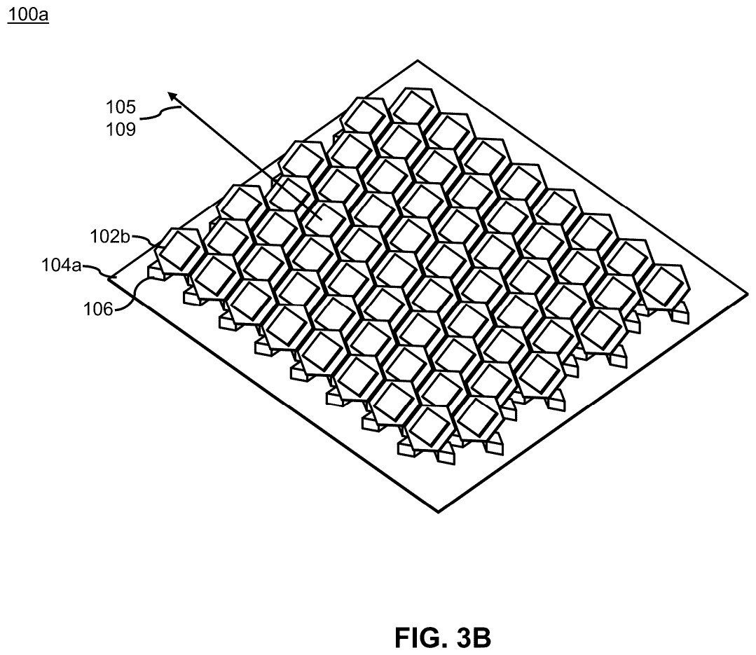

FIGS. 3A-3B illustrate an example of the MEMS steered antenna array 100, in accordance with one or more embodiments of the present disclosure. In this example, the MEMS steered antenna array 100 includes the antenna elements 102 which are the patch-antenna elements 102b. The antenna elements 102 are arranged in the triangular lattice in an 8 -by-8 configuration. The micro-electromechanical systems 106 are illustrated as changing the mechanical steering angles 109 of the antenna elements 102 from being at the normal axis (e.g., 0°) to being 30° relative to the normal axis.

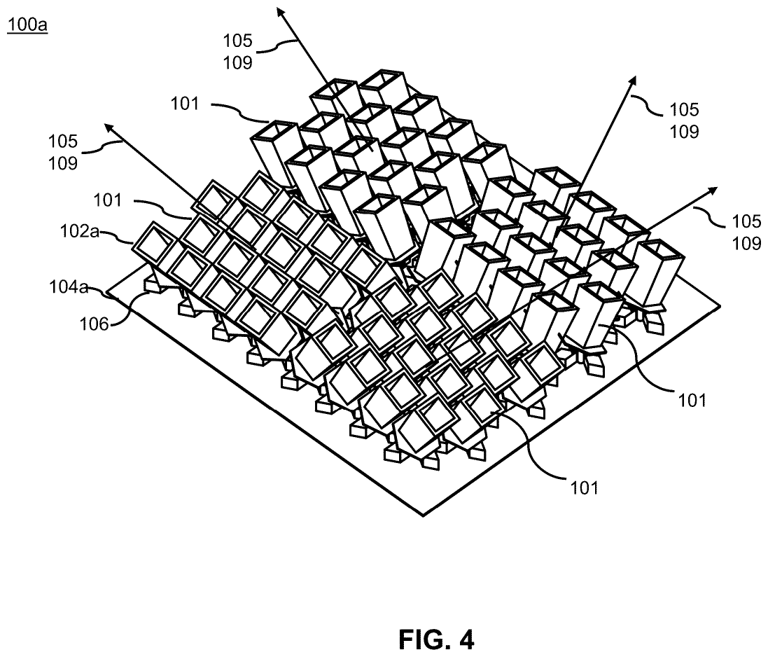

FIG. 4 illustrates an example of the MEMS steered antenna array 100, in accordance with one or more embodiments of the present disclosure. In this example, the antenna elements 102 are grouped into four of the subarrays 101, each in one quadrant of the MEMS steered antenna array 100. The subarrays 101 each include the antenna elements 102 arranged in the triangular lattice in the 4 -by-4 configuration.

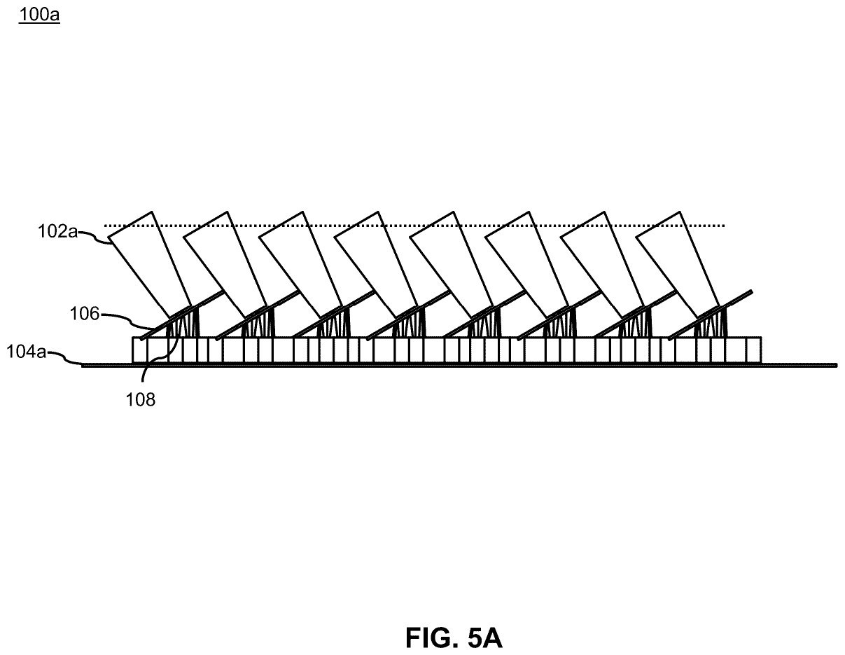

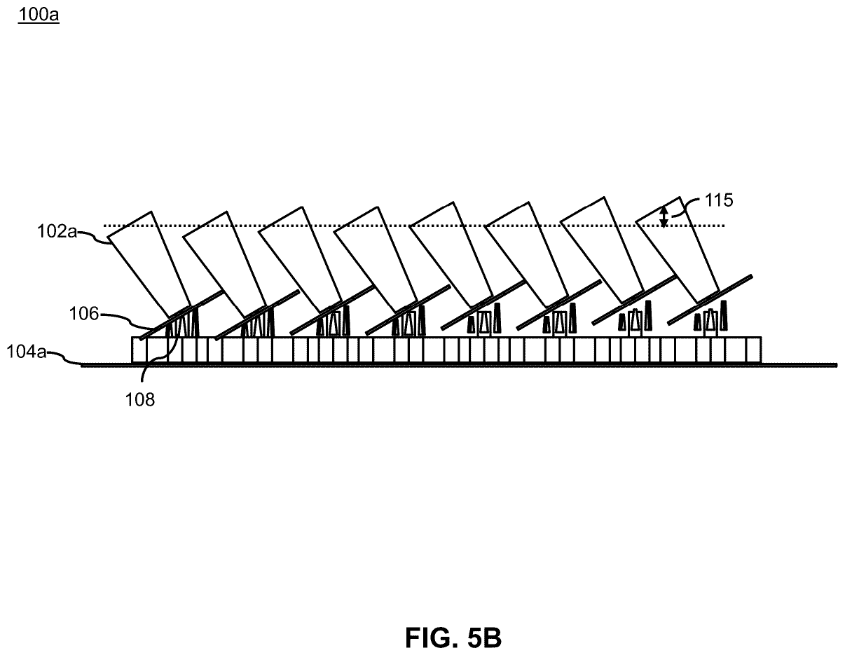

FIGS. 5A-5B illustrates an example of the MEMS steered antenna array 100, in accordance with one or more embodiments of the present disclosure. In this example, the micro-electromechanical systems 106 set the mechanical steering angles 109 of the antenna elements 102 at 30° relative to the normal axis, although this is not intended to limiting. The beamformer 110 causes the micro-electromechanical systems 106 to perform the piston 115 of the antenna elements 102 to correct for the shadowing from adjacent of the antenna elements 102.

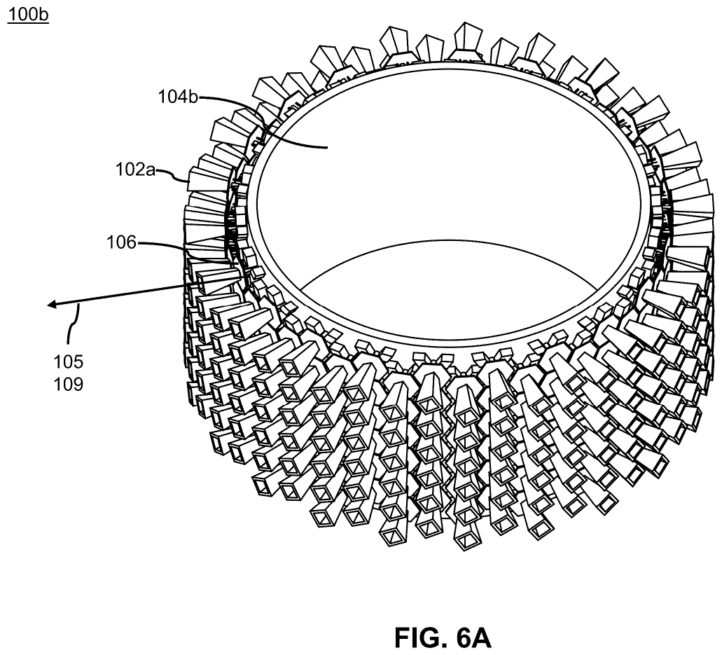

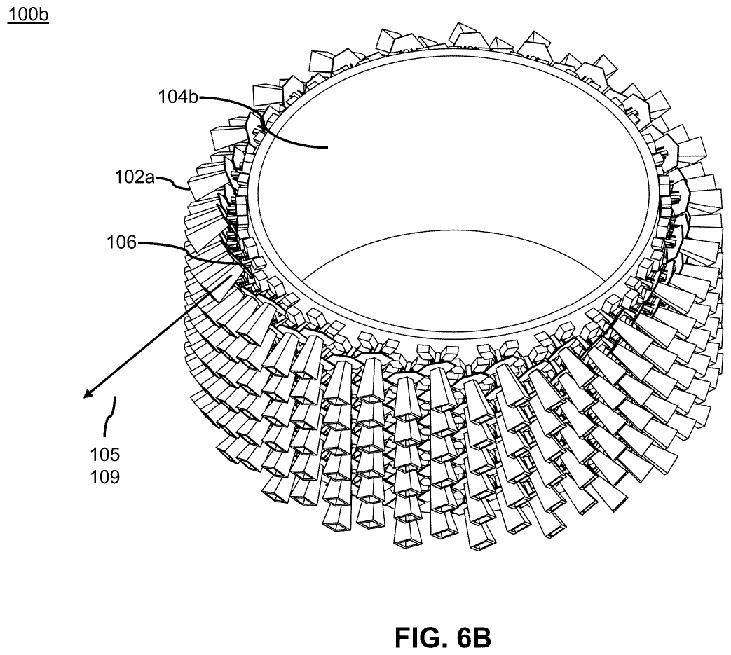

FIGS. 6A-6B illustrate an example of the MEMS steered antenna array 100, in accordance with one or more embodiments of the present disclosure. In this example, the MEMS steered antenna array 100 is the singly-curved conformal array 100b. The substrate 104 is the singly-curved substrate 104b, which in this example shaped as the cylinder. In as a particular example, the MEMS steered antenna array 100 includes the antenna elements 102 which are the horn-antenna elements 102a. Other radiating elements are better suited for this type of array but horn elements as depicted for conceptual clarity. The antenna elements 102 are arranged in the triangular lattice in an 8-by-22 configuration, with 8 rows of the antenna elements 102 along the center axis and 22 columns of the antenna elements 102 revolved about the center axis. The micro-electromechanical systems 106 are illustrated as changing the mechanical steering angles 109 of the antenna elements 102 from being at the normal axis (e.g., 0°) to being 30°relative to the normal axis. The normal axis of the antenna elements 102 is illustrated as being orthogonal to the center axis of the MEMS steered antenna array 100.

Elevation beam scanning may be accomplished by electromechanically tilting the columnar linear arrays along the axis of the singly-curved conformal array 100b. Beam steering can be used enhance in a hybrid system where conventional electronic beam scanning enhance electromechanical steering. Electromechanical tiling in the plane perpendicular to the axis of the singly-curved conformal array 100b may enhance the required subarray azimuthal commutation and electronic beam scanning. Directional cylindrical arrays only activate only about ⅓ of the circumferential arc traversing the exterior surface of the singly-curved conformal array 100b for any given azimuthal beam steering position. Cylindrical arrays do not 1^{st} order suffer from scan projection loss in the azimuth plane, so the element tipping in this plane only has limited performance improvement. Mechanical tilting toward the center of the active directional mode arc would offer some advantage in causing the active element pattern of each radiating element to have somewhat improved spatial alignment for more planar aperture-like behavior.

Multiple directional beams in azimuth are possible with a complicated feed network. Omni-modes are also possible with this structure in accordance with circular mode theory as commonly known in the art.

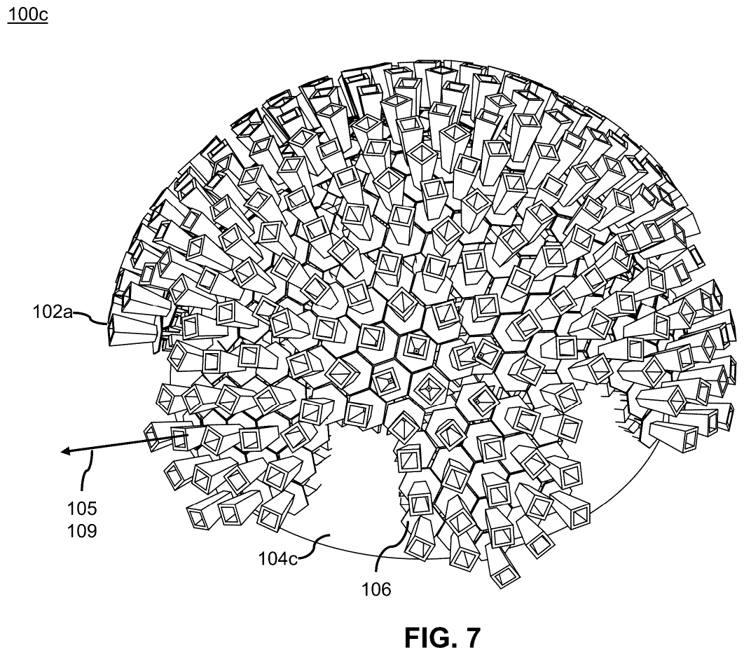

FIG. 7 illustrates an example of the MEMS steered antenna array 100, in accordance with one or more embodiments of the present disclosure. In this example, the MEMS steered antenna array 100 is the doubly-curved conformal array 100c. The substrate 104 is the doubly-curved substrate 104c, which in this example shaped as the hemisphere. In this example, the MEMS steered antenna array 100 includes the antenna elements 102 which are the horn-antenna elements 102a, for illustration. The antenna elements 102 are arranged in the triangular lattice which is arranged in spherical coordinates along the surface of the substrate 104. For the directional modes, hemispherical MEMS Steered Antenna Arrays that are double curved subarrays are commutated about the semispherical sub-surfaces, similar to that described for the cylindrical array architectures. Again, double curved array 1^{st} order do not suffer from scan projection loss in either plane of curvature, so electrometrical tilting could somewhat align the active element patterns in terms of beam pointing direction, as described previously for the singly curved array cylindrical array.

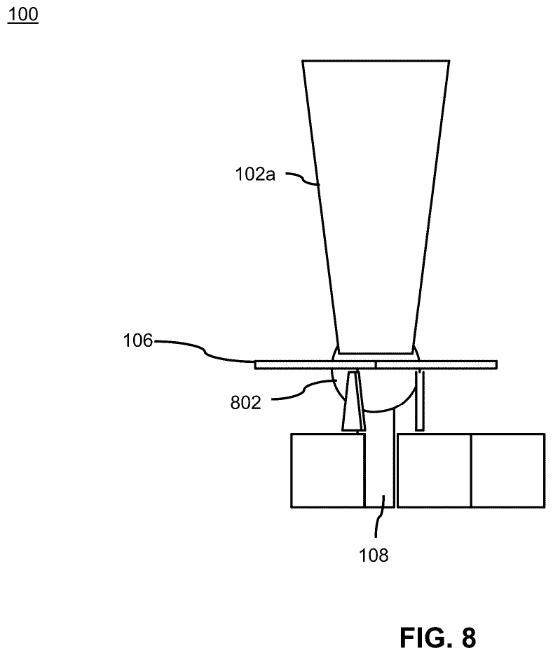

FIG. 8 illustrates an example of the MEMS steered antenna array 100, in accordance with one or more embodiments of the present disclosure. The MEMS steered antenna array 100 may include ball-and-socket joints 802. The ball-and-socket joints 802 may connect between the transmission lines 108 and the antenna elements 102. The radio signals 103 may pass between the transmission lines 108 and the antenna elements 102 through the ball-and-socket joints 802. The ball-and-socket joints 802 may be affixed to the end of the transmission lines 108. The antenna elements 102 may experience the tip 111, the tilt 113, and/or the piston 115 relative to the ball-and-socket joints 802. The ball-and-socket joints 802 may maintain the electrical connect with the tip 111, the tilt 113, and/or the piston 115 of the antenna elements 102. The ball-and-socket joints 802 may be beneficial to enable the connection without adjusting the impedance of the ball-and-socket joints 802 as the tip 111, the tilt 113, and/or the piston 115 of the antenna elements 102 is changed. The ball-and-socket joints 802 may be manufactured by microelectronics scale additive manufacturing. The ball-and-socket joints 802 may be a three-dimensional rotatory joint. The ball-and-socket joints 802 may be a capacitively coupled rotational mm-Wave joint to accommodate the tip 111 and the tilt 113. The ball-and-socket joints 802 may be used in combination with or alternatively to the transmission lines 108 which are flexible. For example, the ball-and-socket joints 802 may be used with the transmission lines 108 which are rigid, replacing the need for the flexibility.

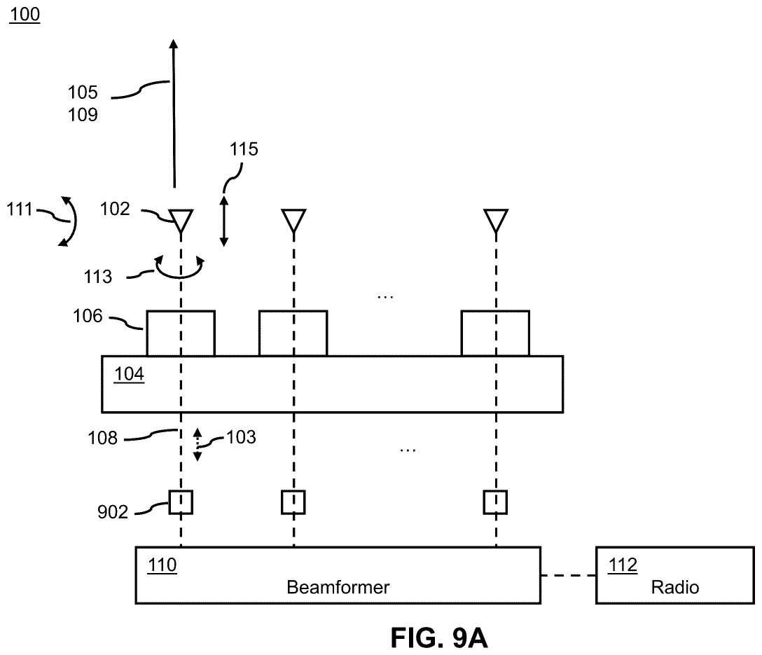

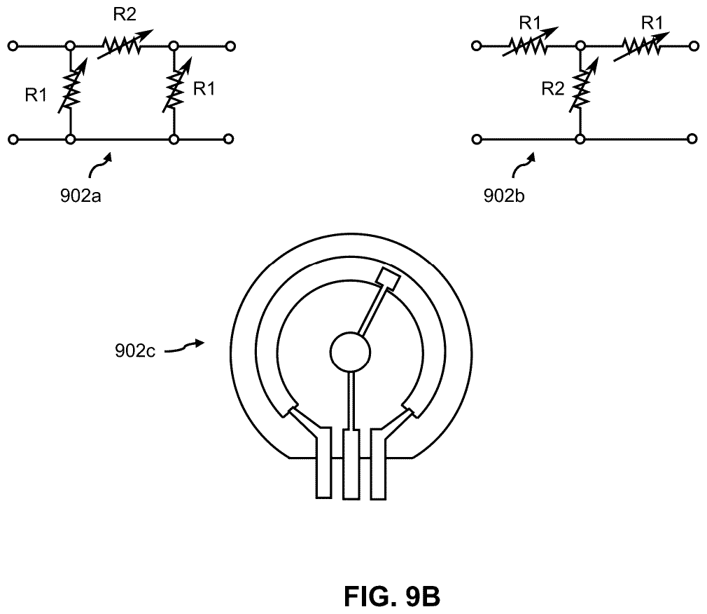

FIG. 9A-9B illustrates the MEMS steered antenna array 100, in accordance with one or more embodiments of the present disclosure. The MEMS steered antenna array 100 may include variable attenuators 902. The variable attenuators 902 may be used for some or all of the element RF signal routing paths. For example, the variable attenuators 902 may be coupled between the antenna elements 102 and the beamformer 110, may be coupled along the transmission lines 108, may be within the beamformer 110, may be within a feed distribution manifold, or the like. The variable attenuators 902 may attenuate the antenna elements 102 (e.g., the radio signals 103 to and from the antenna elements 102). The variable attenuators 902 may be variable to provide amplitude control of the antenna elements 102. The variable attenuators 902 may implement a variable attenuation for all of some of the element radio frequency beamforming signal routing path to enable amplitude tapering to realize lower far field peak side lobe levels, as known in the art, but at the expense of reduction of aperture efficiency to the dissipative losses with passive feed manifold beamforming circuitry. The variable attenuation may be used with or without time/phase control of the antenna elements 102. The variable attenuators 902 may include any suitable variable attenuator, such as, but not limited to, a Pi-pad variable attenuator 902a, a T-pad variable attenuator 902b, a MEMS-based wiper-based potentiometers 902c, or the like.

Referring generally again to figures. It is contemplated that all permutations of the MEMS steered antenna array 100, the subarrays 101, the antenna elements 102, the substrate 104, the micro-electromechanical systems 106, the transmission lines 108, the beamformer 110, the radio 112, and the like may be separately and jointly combinable.

For the electronic digital beamformer, the radio signals 103 may be detected and digitized at each of the antenna elements 102. The digitized signals may then process the digital beamformer to form a desired beam on transmit and/or receive through digital signal processing algorithmic techniques.

It may be desirable for the MEMS steered antenna array 100 to keep the beamformer 110 close to the antenna elements 102 to minimize length of the transmission lines 108 and the length the radio signals 103 travels between the antenna elements 102 and the beamformer 110. Keeping the beamformer 110 close to the antenna elements 102 may be desirable to limit changes in the impedance of the transmission lines 108. The beamformer 110 may be disposed at any suitable position relative to the antenna elements 102. For example, the beamformer 110 may disposed on the opposite side of the substrate 104 to the antenna elements 102 and the micro-electromechanical systems 106. For instance, the beamformer 110 may be beamformer chips formed on the backside of the substrate 104, circuit card electromechanical controller and with a backend coupled to the substrate 104. The beamformer 110 may be an electromechanical controller/electronic beamformer.

The substrate 104 may include vias (not depicted) or the like to connect between the transmission lines 108 and the beamformer 110 where the beamformer 110 is disposed on the opposite side of the substrate 104 as the antenna elements 102 and the micro-electromechanical systems 106.

The electromechanical array can utilize a passive or active feed manifold for both transmission and reception. Each of the transmission lines 108 may be the same length. Having the transmission lines 108 be the same length may ensure signals are time delay matched to minimize beam squint, the transmission lines 108 may be time delay adjusted by the proper choice of line length differences. Phase-matching and/or time delay matching the signals will simplify calibration of the MEMS steered antenna array 100.

The mechanical steering of the antenna elements 102 may be beneficial to reduce the requirements of the beamformer 110. For example, the beamformer 110 may not require active beamformer circuitry for moderate scan angles off the array boresight (array) normal for a planar array, which may greatly simplify the architecture of the MEMS steered antenna array 100 and may reduce direct current (DC) power consumption of the MEMS steered antenna array 100.

The micro-electromechanical systems 106 may include a select level of accuracy in steering the antenna elements 102 at the mechanical steering angles 109. The level of accuracy may be less than the level of accuracy when electrically steering the antenna elements 102 at the electrical steering angles 105. For example, the micro-electromechanical systems 106 may mechanically steering the antenna elements 102 at the mechanical steering angles 109 within 1°. For the case where higher gain radiating elements are used, horns for example, misalignment between the antenna elements 102 may reduce the gain of the MEMS steered antenna array 100, but still provides the benefit from the mechanical steering angles 109. For example, if the MEMS steered antenna array 100 attempts to mechanically steer the antenna elements 102 at the mechanical steering angles 109 of 45 degrees instead tilted one or more of the antenna elements 102 to 46 degrees, the MEMS steered antenna array 100 may lose the amount of gain of the antenna pattern between 45 and 46 degrees. For instance, the one of the antenna elements 102 which is mechanically misaligned may lose more than a dB if not aligned. Averaging across the antenna elements 102, assuming random electromechanical pointing errors, may reduce the significance from slight mechanical angular misalignments.

The radio 112 may be configured to perform tracking. For example, the radio 112 may track an object by using the beamformer 110 to continuously mechanically and electrically steer the antenna elements 102 in alignment with the object.

The electromechanical MEMS steered embodiment of the MEMS steered antenna array 100 may be extremely low-cost while also realizing minimal average DC power consumption. It is contemplated that the MEMS steered antenna array 100 may be used in various applications. The MEMS steered antenna array 100 may be used for communications, radar, and the like. The MEMS steered antenna array 100 may be advantageous with small air vehicles, unmanned aerial vehicles, air-launched effects (ALE), or the like that are real estate challenged. The MEMS steered antenna array 100 may be used for UAV Command and Control. The data link scanning array may be particularly advantageous for the air-launched effects or the like. The singly-curved conformal array 100b and/or the doubly-curved conformal array 100c may be advantageous for integration into real estate challenged platforms with semi-conformal arrays. The conformity of the singly-curved conformal array 100b and/or the doubly-curved conformal array 100c may provide a profile for tight integration into an aerodynamic surface/mold line for low-aerodynamic drag, wide field-of-View. For example, the singly-curved conformal array 100b may be used as an aircraft sensor pod conformal antenna. The ultra-wide band log-periodic array may be a direction finding and/or signal intelligence (DF/SIGINT) array for various air platforms that require elevation scan capability. The MEMS steered antenna array 100 may be used as data link scanning array The MEMS steered antenna array 100 may be advantageous to enabling the mechanical scanning-only embedment since small amounts of direct current power is required. The MEMS steered antenna array 100 may be beneficial for very low power in limited real estate/DC power/thermal management constraints.

The beamformer 110 may include any suitable type of beamformer for controlling the phase and/or amplitude of the antenna elements 102. The beamformer 110 may be an analog beamformer, a digital beamformer, a hybrid analog-digital beamformer, or the like. The beamformer 110 may include an electronic digital beamforming (DBF) architecture. The analog beamforming may also be referred to as radio-frequency beamforming. The analog beamforming may include controlling the phase and/or time delay of the antenna elements 102 which takes place in the radio-frequency domain. The digital beamforming may include controlling the phase and/or time delay control which takes place inside a beamforming computer/processor, after having sampled the radio signals 103 using an A/D convertor (not depicted) between the antenna elements 102 and the beamformer 110. For the digital beamformer, the radio signals 103 may be detected and digitized at each of the antenna elements 102. The digitized signals may then process the digital beamformer to form a desired beam on transmit and/or receive. The hybrid analog-digital beamformer may also be referred to as a subarray beamformer. The hybrid analog-digital beamformer may break the antenna elements 102 into the subarrays 101. The hybrid analog-digital beamformer may control the phase and/or time delay within the subarrays 101. The beamformer 110 may cause the micro-electromechanical systems 106 to mechanically steer the antenna elements 102 where the beamformer 110 is any of the analog beamformer, the digital beamformer, and/or the hybrid analog-digital beamformer.

In its most fundamental form, where only electromechanical bean scanning is utilized, the MEMS steered antenna array 100 may provide an extremely low-cost, mass produce very low DC power consumption ESA architecture viable for SWAP-C and limited real estate applications such as small form factor attritible UAS for platforms with limited DC power sources and limiting thermal management capability, e.g., no on board forced-air liquid cooling. The MEMS steered antenna array 100 may enables infiltration of agilely steered beam directional antenna technologies into RF sensors systems. Also the inherent precision of mechanical MEMS-based antenna element scanning is a significant advantage for millimeter directional antennas, A module can take the form of one or more analog circuits, electronic circuits (e.g., integrated circuits (IC), discrete circuits, system on chip (SOCs) circuits, microcontrollers, etc.), telecommunication circuits, hybrid circuits, and any other type of “circuit.” In this regard, the modules can include any type of component for accomplishing or facilitating achievement of the operations described herein. For example, a circuit as described herein can include one or more transistors, logic gates (e.g., NAND, AND, NOR, OR, XOR, NOT, XNOR, etc.), resistors, multiplexers, registers, capacitors, inductors, diodes, wiring, and so on), and programmable hardware devices (e.g., field programmable gate arrays, programmable array logic, programmable logic devices, or the like). The modules can include a processor and one or more memory devices for storing instructions that are executable by each of the processors.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Those having skill in the art will appreciate that there are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be affected, none of which is inherently superior to the other in that any vehicle to be utilized is a choice dependent upon the context in which the vehicle will be deployed and the specific concerns (e.g., speed, flexibility, or predictability) of the implementer, any of which may vary.

The previous description is presented to enable one of ordinary skill in the art to make and use the invention as provided in the context of a particular application and its requirements. As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period. For example, the memory may be random access memory (RAM), and the results may not necessarily persist indefinitely in the memory.

It is noted herein that the one or more components of system may be communicatively coupled to the various other components of system in any manner known in the art. For example, the one or more processors may be communicatively coupled to each other and other components via a wireline connection or wireless connection.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “connected,” or “coupled,” to each other to achieve the desired functionality, and any two components capable of being so associated can also be viewed as being “couple-able,” to each other to achieve the desired functionality. Specific examples of couple-able include but are not limited to physically mate-able and/or physically interacting components and/or wirelessly inter-actable and/or wirelessly interacting components and/or logically interacting and/or logically inter-actable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed:

1. A micro-electromechanical systems (MEMS) steered antenna array comprising:
a plurality of antenna elements;
a plurality of micro-electromechanical systems mechanically supporting the plurality of antenna elements;
a substrate mechanically supporting the plurality of micro-electromechanical systems, wherein the plurality of micro-electromechanical systems are disposed between the plurality of antenna elements and the substrate;
a beamformer configured to cause the plurality of micro-electromechanical systems to mechanically position the plurality of antenna elements at a plurality of mechanical steering angles; and
a plurality of transmission lines, wherein the plurality of transmission lines connect the plurality of antenna elements and the beamformer.

2. The MEMS steered antenna array of claim 1, wherein the plurality of antenna elements are directional with a gain of at least 3 dB isotropic (dBi).

3. The MEMS steered antenna array of claim 1, wherein the plurality of antenna elements comprise at least one of open-ended waveguide elements, horn-antenna elements, printed antenna elements, spiral elements, helical elements, dielectric resonator elements, slot elements, or Vivaldi-antenna elements.

4. The MEMS steered antenna array of claim 1, wherein the beamformer is configured to control the plurality of micro-electromechanical systems by adjusting a voltage to the plurality of micro-electromechanical systems.

5. The MEMS steered antenna array of claim 1, wherein the plurality of mechanical steering angles are between surface normal and at least 30 degrees from surface normal.

6. The MEMS steered antenna array of claim 1, wherein the plurality of transmission lines extend through a center of respective of the plurality of micro-electromechanical systems.

7. The MEMS steered antenna array of claim 1, wherein the plurality of transmission lines are flexible.

8. The MEMS steered antenna array of claim 1, comprising a plurality of ball-and-socket joints connecting between the plurality of transmission lines and the plurality of antenna elements for polarization alignment.

9. The MEMS steered antenna array of claim 1, wherein the beamformer is configured to cause the plurality of micro-electromechanical systems to mechanically steer the plurality of antenna elements at the plurality of mechanical steering angles as the beamformer causes the plurality of antenna elements to electrically steer at a plurality of electrical steering angles.

10. The MEMS steered antenna array of claim 9, wherein the beamformer is configured to perform phase or time delay steering.

11. The MEMS steered antenna array of claim 9, wherein the beamformer is configured to perform multi-beam and pattern nulling.

12. The MEMS steered antenna array of claim 1, wherein the beamformer is configured to perform linear polarization correction through a tilt of the plurality of antenna elements using the plurality of micro-electromechanical systems.

13. The MEMS steered antenna array of claim 1, wherein a scan rate of electromechanical beam steering of the plurality of antenna elements is on an order of tens of microseconds or hundreds of microseconds.

14. The MEMS steered antenna array of claim 1, wherein the beamformer is configured to cause the plurality of micro-electromechanical systems to compensate for shadowing between the plurality of antenna elements due to the plurality of mechanical steering angles by varying a piston of the plurality of antenna elements across the MEMS steered antenna array using the plurality of micro-electromechanical systems.

15. The MEMS steered antenna array of claim 1, wherein the beamformer is configured to cause the plurality of micro-electromechanical systems to adjust the plurality of mechanical steering angles to random angles to reduce a radar cross section of the MEMS steered antenna array in an off state.

16. The MEMS steered antenna array of claim 1, wherein the plurality of antenna elements are grouped into a plurality of subarrays, wherein the beamformer is configured to mechanically steer the plurality of subarrays at different mechanical steering angles.

17. The MEMS steered antenna array of claim 1, wherein the MEMS steered antenna array is a planar array.

18. The MEMS steered antenna array of claim 1, wherein the MEMS steered antenna array is a singly-curved conformal array.

19. The MEMS steered antenna array of claim 1, wherein the MEMS steered antenna array is a doubly-curved conformal array.

20. The MEMS steered antenna array of claim 1, comprising a plurality of variable attenuators configured to attenuate the plurality of antenna elements.
